(19) United States
(12) Patent Application Publication
(10) Pub. No.: US 2015/0268177 A1
(43) Pub. Date: Sep. 24, 2015

(54) DEFECT DETECTION METHOD

(71) Applicant: Kabushiki Kaisha Toshiba, Minato-ku (JP)

(72) Inventors: Kaito YOKOCHI, Setagaya (JP); Yusuke Iida, Yokkaichi (JP)

(73) Assignee: Kabushiki Kaisha Toshiba, Minato-ku (JP)

(21) Appl. No.: 14/482,412

(22) Filed: Sep. 10, 2014

(30) Foreign Application Priority Data
Mar. 20, 2014 (JP) 2014-057892

(51) Int. Cl. G01N 21/95; G01N 21/956

(52) U.S. Cl. CPC G01N 21/9501; G01N 21/95607; G01N 2201/12

(57) ABSTRACT

According to an embodiment, a defect detection method includes inspecting an inspection target, classifying the inspection target by a characteristic quantity of a signal in the inspection of the inspection target, producing an in-plane map of the inspection target based on the characteristic quantities of the signals in the inspection of the inspection target, calculating a characteristic quantity of an in-plane map of the inspection target, and classifying defects of the inspection target in accordance with an agreement rate between the in-plane map characteristic quantity of the inspection target and an in-plane map characteristic quantity of a reference target.

### CROSS-REFERENCE TO RELATED APPLICATIONS

This application is based upon and claims the benefit of priority from the Japanese Patent Application No. 2014-057892, filed on Mar. 20, 2014; the entire contents of which are incorporated herein by reference.

### FIELD

Embodiments described herein relate generally to a defect detection method.

### BACKGROUND

Among methods for detecting defects in semiconductor wafers, a method is used in which defects to be detected are identified with a scanning electron microscope which classifies optical images according to characteristic quantities (intensity, area, and the like).

Defects include pattern defects such as defects processing deep trenches formed in 3-dimensional memory, and the like. In this type of defect detection method, it is desirable to improve the defect detection and classification accuracy.

### BRIEF DESCRIPTION OF THE DRAWINGS

FIG. 1 is a schematic view illustrating a defect detection device according to a first embodiment;

FIG. 2 is a flowchart showing the defect detection method according to the first embodiment;

FIG. 3 illustrates a wafer;

FIG. 4 illustrates a wafer;

FIG. 5 is a flowchart showing the defect detection method according to a second embodiment;

FIG. 6 illustrates a wafer;

FIGS. 7A and 7B show inspection results of the defect detection device;

FIGS. 8A and 8B illustrate in-plane maps;

FIGS. 9A and 9B illustrate in-plane maps;

FIG. 10 shows the characteristic quantities of the in-plane maps; and

FIG. 11 shows the agreement rate of the characteristic quantities of the in-plane maps.

### DETAILED DESCRIPTION

According to an embodiment, a defect detection method includes inspecting an inspection target, classifying the inspection target by a characteristic quantity of a signal in the inspection of the inspection target, producing an in-plane map of the inspection target based on the characteristic quantities of the signals in the inspection of the inspection target, calculating a characteristic quantity of an in-plane map of the inspection target, and classifying defects of the inspection target in accordance with an agreement rate between the in-plane map characteristic quantity of the inspection target and an in-plane map characteristic quantity of a reference target. The inspection target and the reference target are regions within a semiconductor wafer. The in-plane map characteristic quantities include the incidence rate within an outer peripheral portion calculated from the radial average from the center of the semiconductor wafer, the incidence rate within an inner peripheral portion calculated from the radial average from the center of the semiconductor wafer, or the incidence rate of specific regions when the semiconductor wafer is divided into regions.

Embodiments of the invention will now be described with reference to the drawings.

Note that the drawings are schematic or simplified illustrations and that relationships between thicknesses and widths of parts and proportions in size between parts may differ from actual parts. Also, even where identical parts are depicted, mutual dimensions and proportions may be illustrated differently depending on the drawing.

Note that in the drawings and specification of this application, the same numerals are applied to elements that have already appeared in the drawings and been described, and repetitious detailed descriptions of such elements are omitted.

### First Embodiment

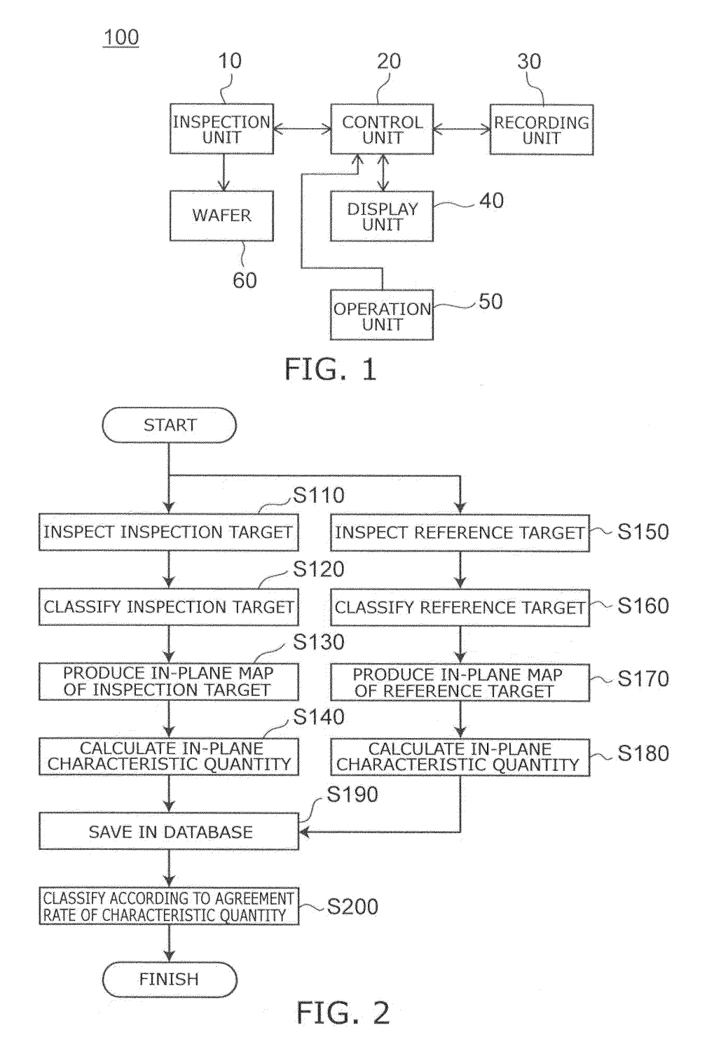

FIG. 1 is a schematic view illustrating a defect detection device 100 according to a first embodiment.

As illustrated in FIG. 1, the defect detection device 100 includes an inspection unit 10, a control unit 20, a recording unit 30, a display unit 40, and an operation unit 50.

The defect detection device 100 acquires a pixel image of the surface of a wafer 60 mounted, for example, on a stage or the like. For example, the inspection unit 10 acquires a pixel image of the surface of the wafer 60. The defect detection device 100 is, for example, an optical detection device. For example, the defect detection device 100 may be a defect detection device 100 using an electron beam.

The inspection unit 10, for example, classifies an inspection target using a characteristic quantity of a detection signal. For example, the inspection unit 10 produces an in-plane map of the inspection target based on a characteristic quantity of the detection signal. The inspection unit 10, for example, calculates an in-plane map characteristic quantity from the in-plane map produced. The inspection unit 10, for example, executes the process described above for a reference target.

A production unit that produces the in-plane maps of the inspection target may be provided in the inspection unit 10. A calculation unit that calculates the in-plane map characteristic quantities may be provided in the inspection unit 10.

The control unit 20 controls, for example, each process within the defect detection device 100. For example, the control unit 20 controls the processes of the inspection unit 10.

The recording unit 30, for example, stores the results detected by the inspection unit 10. The recording unit 30, for example, records the results detected by the inspection unit 10.

The recording unit 30, for example, stores the results of classifying the inspection target using a characteristic quantity of the detection signal. For example, the recording unit 30 stores the in-plane map of the inspection target produced based on the characteristic quantity of the detection signal. The recording unit 30, for example, stores the in-plane characteristic quantity calculated from the in-plane map. The recording unit 30, for example, stores data on the reference target.

The display unit 40, for example, displays the results detected by the inspection unit 10. The display unit 40, for example, displays the results of classifying the inspection target using the characteristic quantity of the detection signal. For example, the display unit 40 displays the in-plane map of the inspection target produced based on the characteristic quantity of the detection signal. The display unit 40, for example, displays the in-plane characteristic quantity calculated from the in-plane map. The display unit 40, for example, displays data on the reference target.

The operation unit 50 is, for example, a keyboard, a mouse, or the like. Using the operation unit 50, instructions are issued to the control unit 20.

The wafer 60 includes, for example, an inspection target (for example, a region with a pattern), and a reference target (for example, a region with no pattern) on the surface of the substrate. For example, the inspection target and the reference target are provided within one chip.

FIG. 2 is a flowchart showing the defect detection method according to a first embodiment.

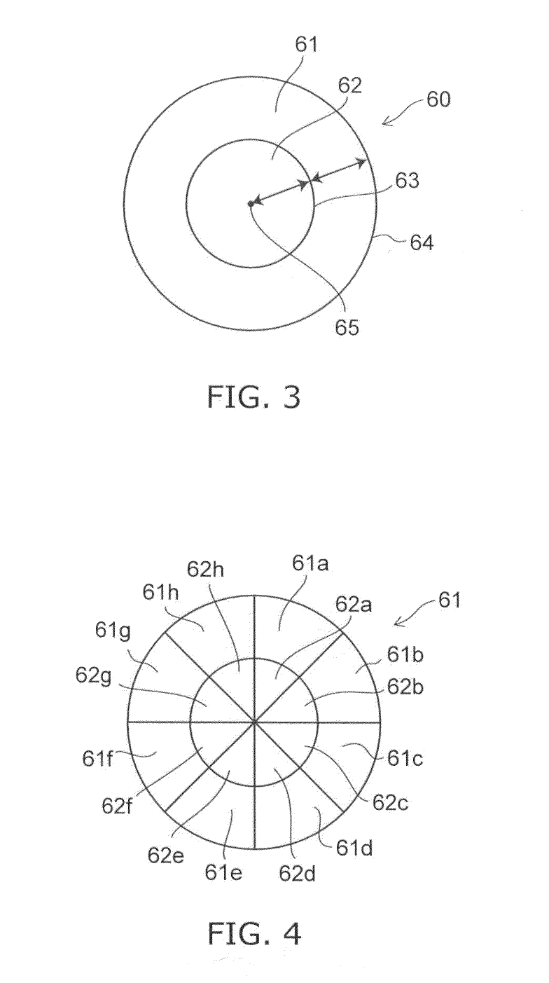

FIG. 3 illustrates a wafer.

FIG. 4 illustrates a wafer.

The defect detection method shown in FIG. 2 is executed by, for example, the defect detection device 100. FIG. 3 illustrates regions of the wafer 60. FIG. 4 illustrates regions of the wafer 60.

The defect detection device 100 inspects the inspection target (step S110). The wafer 60 is mounted on the stage or the like of the defect detection device 100 and the inspection target is inspected. The conditions for inspecting the inspection target are, for example, conditions that the defect detection device 100 can set.

The inspection target is classified using a characteristic quantity of the inspection signal (step S120). The characteristic quantity of the inspection signal is, for example, the intensity with respect to the background, the brightness or darkness relative to the background light, or the area (size), and the like. The inspection target is classified using one or a plurality of characteristic quantities. For example, the inspection target is classified according to a characteristic quantity of an optical image.

An in-plane map of the inspection target is produced based on the characteristic quantity of the inspection signal (step S130).

In-plane characteristic quantities from the in-plane map produced, such as, for example, the incidence rate within the outer peripheral portion calculated from the radial average from the center of the wafer 60, the incidence rate within the inner peripheral portion calculated from the radial average from the center of the wafer 60, the incidence rate for specific regions when the region of the wafer 60 is divided into several regions, or the like, are calculated (step S140).

As illustrated in FIG. 3, the region of the wafer 60 is divided into an outer peripheral portion 61 and an inner peripheral portion 62 by a first boundary 63 and a second boundary 64. The second boundary 64 corresponds to the outermost periphery of the wafer 60. The characteristic quantities are the number of defects from the center 65 of the wafer 60 to the first boundary 63 as a proportion of the total number of defects, and the number of defects from the first boundary 63 to the second boundary 64 as a proportion of the total number of defects.

As illustrated in FIG. 4, the outer peripheral portion 61 and the inner peripheral portion 62 of the wafer 60 are divided into eight equal fan-shaped portions. The number of defects in each of the regions 61a to 61 h and 62a to 62 h as a proportion of the total number of defects are characteristic quantities.

The defect detection device 100 inspects the reference target separately from the inspection target (step S150). The wafer 60 is mounted on the stage or the like of the defect detection device 100 and the reference target is inspected. The conditions for inspecting the reference target are, for example, conditions that the defect detection device 100 can set. The conditions for inspecting the reference target do not have to be the same as the conditions for inspecting the inspection target.

The reference target is classified using a characteristic quantity of the inspection signal (step S160). The characteristic quantity of the inspection signal is, for example, the intensity with respect to the background, the brightness or darkness relative to the background light, or the area (size), and the like. The reference target is classified using one or a plurality of characteristic quantities. For example, the reference target is classified according to a characteristic quantity of an optical image.

An in-plane map of the reference target is produced based on the characteristic quantity of the inspection signal (step S170).

In-plane characteristic quantities from the in-plane map produced, such as, for example, the incidence rate within the outer peripheral portion calculated from the radial average from the center of the wafer 60, the incidence rate within the inner peripheral portion calculated from the radial average from the center of the wafer 60, or the incidence rate for specific regions when the region of the wafer 60 is divided into several regions, or the like, are calculated (step S180). The in-plane characteristic quantities in the inspection target may be set in advance.

The characteristic quantities of the in-plane map of the inspection target and the characteristic quantities of the in-plane map of the reference target are saved in a database (step S190). For example, these characteristic quantities are stored in the recording unit 30 of the defect detection device 100.

The defects of the inspection target are classified in accordance with the agreement rate between the characteristic quantity of the inspection target and the characteristic quantity of the reference target (step S200). The agreement rate C1 (%) is calculated from the following equation (1).

C1=100·|P2−P1|/|P1| (1)

The characteristic quantity of the in-plane map of the inspection target is P1. The characteristic quantity of the in-plane map of the reference target is P2. When classifying the defects of the inspection target, the defects may be classified by dividing into several stages in accordance with the agreement rate C1. When classifying the defects of the inspection target based on the agreement rate C1, the defects may be classified using a threshold value. For example, if the value of the agreement rate C1 is not less than a specific threshold value, the inspection target and the reference target may be judged to have a common characteristic quantity.

The inspection target and the reference target are, for example, a region with a pattern and a region without a pattern. For example, the inspection target and the reference target are a region with a pattern and a region at the edge of a pattern. The inspection target and the reference target are, for example, a region after processing and a region before processing.

When the defect detection method according to this embodiment is used, the defects of the inspection target can be classified from the in-plane characteristic quantities of the inspection target and the reference target. The defects arising in the inspection target can be classified by excluding from the in-plane characteristic quantities the characteristic quantities that are common to the inspection target and the reference target. The defects occurring in the inspection target are classified based on the agreement rate C1.

When the defect detection method according to this embodiment is used, it is possible to classify defects with a high possibility of occurrence in the inspection target.

According to this embodiment, a defect detection method is provided with improved accuracy of detection and classification of defects.

### Second Embodiment

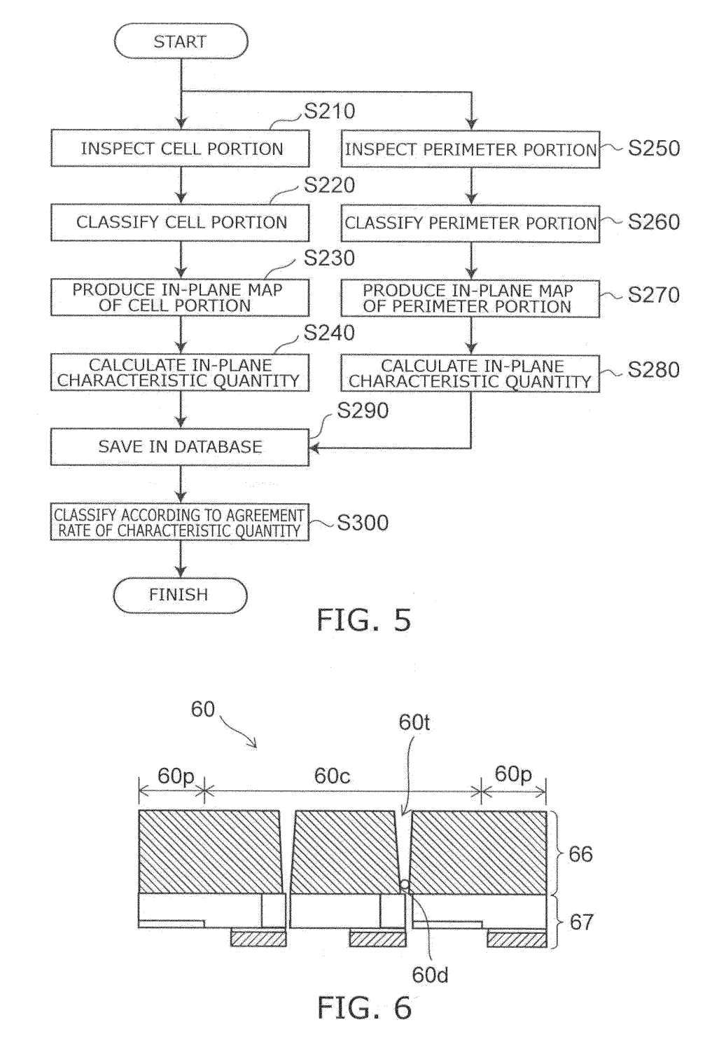

FIG. 5 is a flowchart showing the defect detection method according to a second embodiment.

FIG. 6 illustrates a wafer.

As illustrated in FIG. 6, a stacked body 66 and a complementary metal oxide semiconductor (CMOS) 67 are provided in the wafer 60. The inspection target is a cell portion 60c within the wafer 60. The reference target is a perimeter portion 60p within the wafer 60. The cell portion 60c and the perimeter portion 60p correspond to a region with a pattern and a region without a pattern, respectively. For example, a bottom short defect 60d occurs in a trench 60t of the cell portion 60c.

The cell portion 60c is inspected by the defect detection device 100 (step S210). The wafer 60 is mounted on the stage or the like of the defect detection device 100 and the cell portion 60c is inspected.

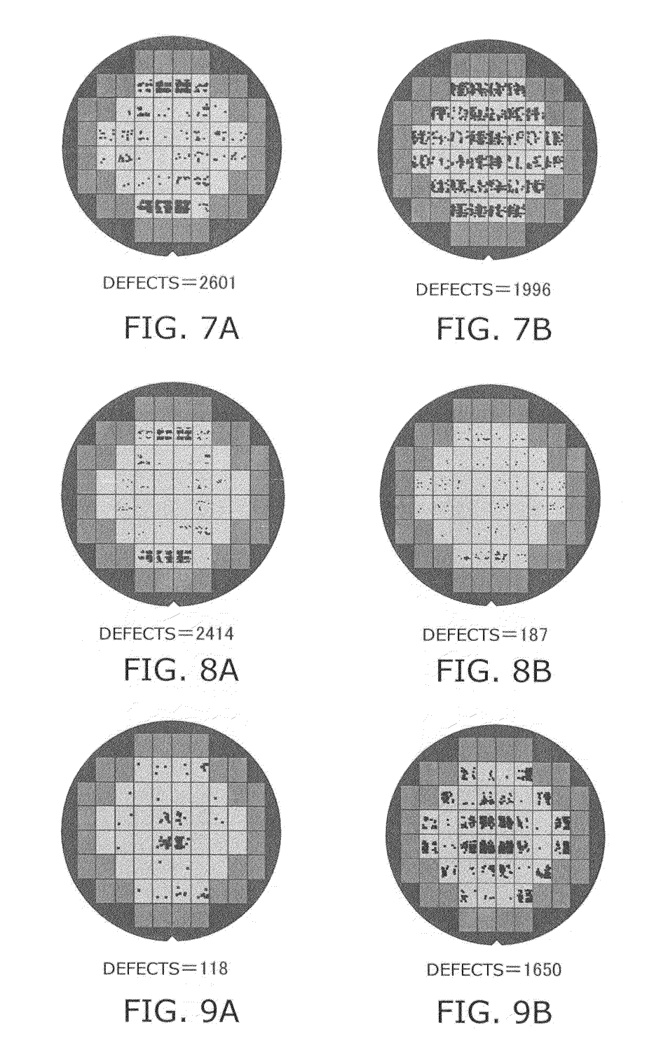

FIGS. 7A and 7B show inspection results of the defect detection device.

The inspection results of the cell portions 60c are shown in, for example, FIG. 7A. FIG. 7A shows the inspection results for a case of a pattern with deep trenches.

The cell portion 60c is classified using a characteristic quantity of the inspection signal (step S220). The characteristic quantity of the inspection signal is, for example, the intensity with respect to the background, the brightness or darkness relative to the background light, or the area (size), and the like. Also, an in-plane map of the cell portions 60c is produced based on the characteristic quantity of the inspection signal (step S230).

FIGS. 8A and 8B illustrate in-plane maps.

The in-plane maps of the cell portions 60c are represented, for example, as illustrated in FIGS. 8A and 8B. FIG. 8A is an in-plane map classified by signals in which the intensity with respect to the background is strong. FIG. 8B is an in-plane map classified by signals in which the intensity with respect to the background is weak.

In-plane characteristic quantities from the in-plane map produced, such as, for example, the incidence rate within the outer peripheral portion calculated from the radial average from the center of the wafer 60, the incidence rate within the inner peripheral portion calculated from the radial average from the center of the wafer 60, or the incidence rate for specific regions when the region of the wafer 60 is divided into several regions, or the like, are calculated (step S240).

The perimeter portion 60p is inspected by the defect detection device 100 independently from the cell portion 60c (step S250). The wafer 60 is mounted on the stage or the like of the defect detection device 100 and the perimeter portion 60p is inspected.

The inspection results of the perimeter portions 60p are shown in, for example, FIG. 7B. FIG. 7B shows the inspection results for a case of no pattern with deep trenches.

The perimeter portion 60p is classified using a characteristic quantity of the inspection signal (step S260). The characteristic quantity of the inspection signal is, for example, the intensity with respect to the background, the brightness or darkness relative to the background light, or the area (size), and the like. Also, an in-plane map of the perimeter portions 60p is produced based on the characteristic quantity of the inspection signal (step S270).

FIGS. 9A and 9B illustrate in-plane maps.

The in-plane maps of the perimeter portions 60p are represented, for example, as illustrated in FIGS. 9A and 9B. FIG. 9A is an in-plane map classified by signals in which the intensity with respect to the background is strong. FIG. 9B is an in-plane map classified by signals in which the intensity with respect to the background is weak.

In-plane characteristic quantities from the in-plane map produced, such as, for example, the incidence rate within the outer peripheral portion calculated from the radial average from the center of the wafer 60, the incidence rate within the inner peripheral portion calculated from the radial average from the center of the wafer 60, or the incidence rate for specific regions when the region of the wafer 60 is divided into several regions, or the like, are calculated (step S280).

The characteristic quantities of the in-plane map of the cell portions 60c and the characteristic quantities of the in-plane map of the perimeter portions 60p are saved in a database (step S290).

The defects of the cell portions 60c are classified in accordance with the agreement rate between the characteristic quantities of the cell portion 60c and the characteristic quantities of the perimeter portions 60p (step (S300). The agreement rate C2 (%) is calculated from the following equation (2).

C2=100·|P4−P3|/|P3| (2)

The characteristic quantity of the in-plane map of the cell portions 60c is P3. The characteristic quantity of the in-plane map of the perimeter portions 60p is P4.

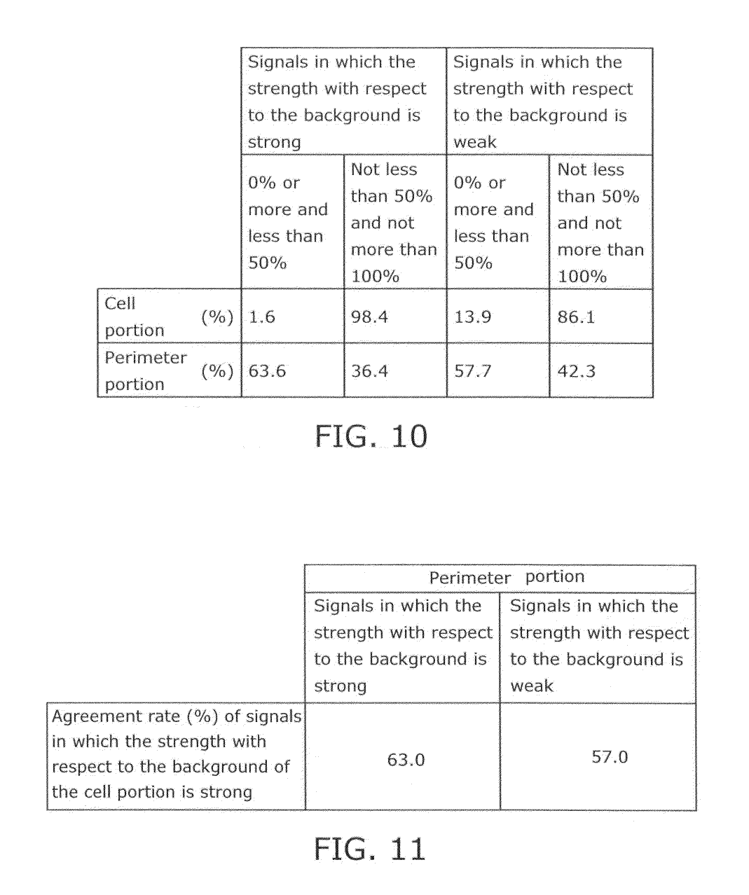

FIG. 10 shows the characteristic quantities of the in-plane maps.

FIG. 11 shows the agreement rate of the characteristic quantities of the in-plane maps.

For example, the agreement rate C2 of the characteristic quantities of the in-plane maps for the cell portions 60c and the perimeter portions 60p is calculated as follows.

If the distance of the outermost periphery (for example, the second boundary 64) from the center of the wafer 60 is 100%, the percentage (%) of defects from 0% to less than 50% and the percentage (%) of defects from 50% to 100% are calculated for each of the cell portions 60c and perimeter portions 60p. The characteristic quantities of the inspection signals are strong signals and weak signals with respect to the background. The cell portions 60c and the perimeter portions 60p are classified according to these characteristic quantities. In FIG. 10, the in-plane map characteristic quantities are shown for the cell portions 60c and the perimeter portions 60p.

For signals whose intensity is strong with respect to the background for the cell portions 60c, the percentage P5 of defects from 50% of to 100% of the distance from the center to the outermost periphery is taken to be the standard. For the perimeter portions 60p, for signals whose intensity is strong with respect to the background, P6 is the percentage of defects from 50% of to 100% of the distance from the center to the outermost periphery, and for signals whose intensity is weak with respect to the background, P7 is the percentage of defects from 50% of to 100% of the distance from the center to the outermost periphery. In this case, the agreement rate C3 and C4 are calculated from the following equations (3) and (4).

C3=100·|P6−P5|/|P5| (3)

C4=100·|P7−P5|/|P5| (4)

By calculating based on the numbers shown in FIG. 10, the agreement rates C3 and C4 are obtained as 63% and 57%, respectively, as shown in FIG. 11. If, for example, the threshold value of the agreement rate was set at 80%, the agreement rates C3 and C4 would be less than or equal to the threshold value, so the signal whose intensity with respect to the background is strong in the cell portions 60c would be classified as an inherent defect of the pattern.

When the defect detection method according to this embodiment is used, the defects of the regions with a pattern can be classified from the in-plane characteristic quantities of the regions with a pattern and the regions without a pattern. Defects that occur in the regions with a pattern are classified by excluding from the in-plane characteristic quantities the characteristic quantities that are common between the regions with a pattern and the regions without a pattern. Defects occurring in a region with a pattern are classified based on the agreement rate C. For example, for cell portions with a pattern within a semiconductor wafer and for perimeter portions without a pattern within a semiconductor wafer, defects occurring in the cell portions can be classified by comparing the in-plane characteristic quantities.

Also, there is a high possibility of occurrence of bottom short and pattern edge roughness (unevenness) and the like in the cell portions. There is a high possibility of occurrence of film roughness and CMOS noise and the like in the cell portions and the perimeter portions. Bottom shorts occur due to deep trench processing defects or deep hole processing defects. It is difficult for a scanning electron microscope (SEM) image acquisition-type inspection device to observe defects due to faulty processing of deep trenches and defects due to faulty processing of deep holes. It is difficult for bottom layer defects such as these to be classified as defects by an SEM image acquisition type inspection device.

When the defect detection method according to this embodiment is used, it is possible to classify defects with a high possibility of occurrence in the cell portions. This type of defect detection method can be used for 3-dimensional memory.

According to this embodiment, a defect detection method is provided with improved accuracy of detection and classification of defects.

Embodiments of the invention with reference to examples were described above. However, the invention is not limited to these examples. For example, if a person with ordinary skill in the art to which this invention pertains carries out the invention in the same way by selecting the specific constitutions of the defect detection method, and, the inspection unit, the control unit, the recording unit, the display unit, and the operation unit and the like included in the defect detection device, and the like as appropriate from the publicly known scope and can obtain the same results, then it is included within the scope of the invention.

Moreover, combinations of two or more components in the specific examples within a technically feasible range are also included in the scope of the invention as long as the spirit of the invention is included.

In addition, any defect detection device and defect detection method, which those skilled in the art can carry out by making appropriate design modifications based on the defect detection device and the defect detection method described above as the embodiments of the invention, are also in the scope of the invention as long as the spirit of the invention is included.

Also, within the scope of principles of the invention, various changes and modifications will be readily made by those skilled in the art. Accordingly, it will be appreciated that such changes and modifications also fall within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A defect detection method, comprising:
inspecting an inspection target;
classifying the inspection target by a characteristic quantity of a signal in the inspection of the inspection target;
producing an in-plane map of the inspection target based on the characteristic quantities of the signals in the inspection of the inspection target;
calculating an in-plane map characteristic quantity of the inspection target; and
classifying defects of the inspection target in accordance with an agreement rate between the in-plane map characteristic quantity of the inspection target and an in-plane map characteristic quantity of a reference target,
the inspection target and the reference target being regions within a semiconductor wafer, the in-plane map characteristic quantities including the incidence rate within an outer peripheral portion calculated from the radial average from the center of the semiconductor wafer, the incidence rate within an inner peripheral portion calculated from the radial average from the center of the semiconductor wafer, or the incidence rate of specific regions when the semiconductor wafer is divided into regions.

2. The method according to claim 1, further comprising:
inspecting the reference target;
classifying the reference target by a characteristic quantity of a signal in the inspection of the reference target;
producing an in-plane map of the reference target based on the characteristic values of the signals in the inspection of the reference target; and
calculating the in-plane map characteristic quantity of the reference target.

3. The method according to claim 1, further comprising recording the in-plane map characteristic quantities of the inspection target, and the in-plane map characteristic quantities of the reference target.

4. The method according to claim 1, wherein the inspection target is a region with a pattern, and
the reference target is a region without a pattern.

5. The method according to claim 1, wherein the inspection target is a region with a pattern, and
the reference target is a region at the edge of a pattern.

6. The method according to claim 1, wherein the inspection target is a region after processing, and
the reference target is a region before processing.

7. The method according to claim 1, wherein the characteristic quantity of the signal is the intensity with respect to a background, the brightness or darkness relative to background light, or an area.

8. The method according to claim 1, wherein the defects of the inspection target are classified based on a threshold value of an in-plane map characteristic quantity.

9. The method according to claim 1, wherein a region within the semiconductor wafer has a first boundary and a second boundary,
the outer peripheral portion is a portion provided between the first boundary and the second boundary, and
the inner peripheral portion is a portion provided inside the first boundary.

10. The method according to claim 1, wherein the characteristic quantity of the in-plane map is the number of defects in the inner peripheral portion as a proportion of the total number of defects within the region.

11. The method according to claim 1, wherein the characteristic quantity of the in-plane map is the number of defects in the outer peripheral portion as a proportion of the total number of defects within the region.

12. The method according to claim 1, wherein the outer peripheral portion and the inner peripheral portion are each divided into a plurality of equal regions, and
the characteristic quantity of the in-plane map is the number of defects in each of the plurality of regions as a proportion of the total number of defects.

13. A defect detection device, comprising an inspection unit that inspects an inspection target and a reference target provided within a semiconductor wafer,
the inspection unit classifying the inspection target and producing an in-plane map of the inspection target based on a characteristic quantity of a signal in the inspection of the inspection target,
the inspection unit classifying the reference target and producing an in-plane map of the reference target based on a characteristic quantity of a signal in the inspection of the reference target, and
the inspection unit calculating characteristic quantities for the in-plane map of the inspection target and the in-plane map of the reference target, and classifying the defects of the inspection target in accordance with an agreement rate between the in-plane map characteristic quantity of the inspection target and the in-plane map characteristic quantity of the reference target.

14. The device according to claim 13, wherein the in-plane map characteristic quantities include the incidence rate within an outer peripheral portion calculated from the radial average from the center of the semiconductor wafer, the incidence rate within an inner peripheral portion calculated from the radial average from the center of the semiconductor wafer, or the incidence rate of specific regions when the semiconductor wafer is divided into regions.

15. The device according to claim 13, further comprising a recording unit that records the in-plane map characteristic quantities of the inspection target, and the in-plane map characteristic quantities of the reference target.

16. The device according to claim 13, wherein the inspection target is a region with a pattern, and
the reference target is a region without a pattern.

17. The device according to claim 13, wherein the inspection target is a region with a pattern, and
the reference target is a region at the edge of a pattern.

18. The device according to claim 13, wherein the inspection target is a region after processing, and the reference target is a region before processing.

19. The device according to claim 13, wherein the characteristic quantity of the signal is the intensity with respect to a background, the brightness or darkness relative to background light, or an area.

20. The device according to claim 13, wherein the inspection unit classifies defects of the inspection target based on a threshold value of the characteristic quantities of the in-plane map.
